(19) United States
(12) Patent Application Publication
(10) Pub. No.: US 2013/0093779 A1
(43) Pub. Date: Apr. 18, 2013

(54) GRAPHICS PROCESSING UNIT MEMORY USAGE REDUCTION

(71) Applicants: Martin S. Lyons, Hendereson, NV (US); Roderick Ang, Las Vegas, NV (US)

(72) Inventors: Martin S. Lyons, Hendereson, NV (US); Roderick Ang, Las Vegas, NV (US)

(73) Assignee: BALLY GAMING, INC., Las Vegas, NV (US)

(21) Appl. No.: 13/273,611

(22) Filed: Oct. 14, 2011

(51) Int. Cl. G09G 5/36

(52) U.S. Cl. 345/547; 345/555

(57) ABSTRACT

A memory usage reduction system optimizes GPU memory usage by reducing the memory footprint of graphical resources, and therefore, the amount of memory necessary to store those graphical resources in GPU memory. In one embodiment, the system comprises a CPU with a system memory in communication with a GPU with a video memory. Graphical resources are stored on the system memory. A data collection process intercepts or modifies function calls to the GPU from the CPU to build a data record as the graphical resources are read from the system memory and loaded into the video memory. The data record identifies which graphical resources are to be loaded into the video memory in the compressed or uncompressed state. The GPU may encode the graphical resources. Encoding may be done during a pre-boot operation. The GPU may decode the graphical resources on the fly when needed for rendering during normal operation.

### CROSS-REFERENCE TO RELATED APPLICATIONS

This application is related to co-pending U.S. patent application Ser. No. 13/273,555, entitled “Streaming Bitrate Control And Management,” filed on Oct. 14, 2011.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This description relates to reducing the memory footprint of graphical resources on video memory.

### BACKGROUND

Current systems that render graphics generally use a central processing unit (CPU) having a corresponding system memory, and a graphics processing unit (GPU) having a corresponding video memory. The CPU sends instructions to the GPU to draw visual elements for rendering into a frame buffer in the video memory. The instructions typically comprise commands to draw graphical primitives such as shapes, polygons, textures, coordinates, and other metadata. Graphical primitives that are frequently used or of a particular size are often cached in the video memory to avoid saturating the data bus between the CPU and GPU. Even though the video memory generally reserves a region for one or more frame buffers, most of the memory is usually reserved for and consumed by textures. Textures are generally used to add detail to an underlying graphical primitive such as a line, polygon, or surface by using a process known as texture mapping. Otherwise stated, textures give the illusion of geometric complexity.

Textures vary from application to application. For example, in a casino gaming environment, a texture may include a reel symbol, button icon, or logo on an electronic gaming machine (EGM) that presents a slot machine style game. In an application involving an EGM that presents a Blackjack game, a different texture may correspond to the chip icons and the individual rank and suit of each playing card. For example, a rectangle may be mapped with an Ace of Spades texture or a King of Hearts texture. Another example highlights the importance of texture mapping. A game may depict a brick wall. Without texture mapping, the brick wall may be presented by a multitude of offset and adjacent rectangles. However, the geometric complexity may be reduced by mapping a texture, such as a bitmap derived from an image, or even an animation, of a brick wall, over a single large rectangle.

Textures may generally be categorized as static or dynamic. Static textures are derived from graphical data such as images or animations whereas dynamic textures are derived from graphical data such as a streamed animation, i.e., an animation that is accessed as a stream (frame by frame). The graphical data corresponding to both static and dynamic textures may be stored in system memory in a lossy or lossless compressed state. During a pre-load boot process, the CPU or GPU usually decompresses the compressed graphical data corresponding to static textures and stores the uncompressed textures in the video memory associated with the GPU. For example, a compressed image (i.e., non-animated graphic) may be decompressed and stored as a single texture in video memory. Similarly, each frame corresponding to an animation may be decompressed and stored as an individual texture in video memory. With respect to dynamic textures, the CPU or GPU usually decompresses the compressed graphical data as each frame is needed for rendering rather than pre-load the video memory with all frames during the pre-load boot process as is done for static textures. For example, the first frame of a streamed animation may be decompressed, stored in video memory, rendered, and then discarded prior to decompression of the next frame in the streamed animation.

The use of textures has resulted in video memory being fully utilized (or very close to being fully utilized) by designers. Accordingly, though the storage of textures on the video memory reduces the amount of data transferred from the CPU to the GPU, such memory consumption affects the number of games or instances of software that may be run in a virtualized environment. Thus, the advent of virtualization has generated a need to reduce the consumption of memory associated with the GPU. More specifically, virtualization enables multiple games or other software to be run on a single server employing a CPU and GPU provided that there are enough system resources (e.g., video memory) for each game or software instance. Thus, there is a need to provide more memory considering a single game is often designed to fully utilize video memory. One solution comprises introducing more hardware; however, this adds cost and may only be possible with custom hardware depending on the amount of memory sought to be added. Accordingly, there continues to be a need for improvements in the area of virtualization; and more particularly, the memory associated with a virtualized environment.

### SUMMARY

Briefly, and in general terms, various embodiments are directed to a system and method for reducing the memory footprint of an application on video memory.

In some embodiments, memory usage corresponding to a video memory associated with a graphics processing unit is reduced by performing a data collection process on one or more graphical resources stored on a system memory associated with a central processing unit. The data collection process is performed as each graphical resource is read from the system memory and loaded in the video memory. A data record is built based on information collected during the data collection process. It is determined whether the graphical resources are to be compressed prior to loading into the video memory based on the data record. Based on this determination, graphical resources are compressed or not compressed prior to loading into the video memory. Compressed and uncompressed graphical resources may be loaded into the video memory based on the data record. Compressing graphical resources reduces their corresponding memory footprint. Loading compressed graphical resources in place of their uncompressed counterparts reduces the amount of video memory used.

In some embodiments, memory usage corresponding to a graphics processing unit is reduced by also performing a compression quality process on one or more of the graphical resources. The compression quality process includes performing a peak-signal-to-noise ratio calculation on an original and compressed version of a graphical resource (e.g., a single frame for an image or a frame amongst a plurality of frames for an animation). The result of the calculation is compared against a threshold value and a flag is set (e.g., created, set, altered, and the like) based on the comparison. The static/dynamic flag may be set, or a load flag may be set, depending on the embodiment. In some embodiments, both flags are used in conjunction with one another. Video memory usage may be reduced because a high compression ratio may satisfy the threshold value (e.g., 4:1, 8:1, 16:1, and the like) even though a low compression ratio also satisfies the threshold value (e.g., 1.5:1, 2:1, 3:1, and the like). In such an embodiment, the technique employing the higher compression ratio is chosen over the technique employing the lower compression ratio because the threshold value (i.e., quality measure) was met. Accordingly, what may have been initially compressed at a 2:1 or 3:1 ratio may ultimately be compressed at a higher ratio as a result of the compression quality process prior to load into the video memory.

In some embodiments, a memory usage reduction system includes a first processing unit in communication with a graphics processing unit. The first processing unit has an associated memory and graphics processing unit has an associated memory. The first processing unit and the graphics processing unit have one or more circuits or software for performing a data collection process on one or more graphical resources stored on the memory associated with the first processing unit. A data collection process is performed as each graphical resource is read from the memory associated with the first processing unit and stored in the memory associated with the graphics processing unit. A data record is built based on information collected during the data collection process. It is determined whether the graphical resources are to be compressed prior to loading into the memory associated with the graphics processing unit based on the data record. Based on this determination, graphical resources are compressed or not compressed prior to loading into the memory associated with the graphics processing unit. Compressed and uncompressed graphical resources may be loaded into the memory associated with the graphics processing unit based on the data record. Compressing graphical resources reduces their corresponding memory footprint. Loading compressed graphical resources in place of their uncompressed counterparts reduces the usage of memory that is associated with the graphics processing unit.

The first processing unit and the graphics processing unit may also have one or more circuits or software for performing a compression quality process on one or more of the graphical resources. The compression quality process includes performing a peak-signal-to-noise ratio calculation on an original and compressed version of a graphical resource (e.g., a single frame for an image or a frame amongst a plurality of frames for an animation). The result of the calculation is compared against a threshold value and a flag is set (e.g., created, set, altered, and the like) based on the comparison. The static/dynamic flag may be set, or a load flag may be set, depending on the embodiment. In some embodiments, both flags are used in conjunction with one another.

In some embodiments, a memory usage reduction system in a virtualized environment includes a server in communication with a plurality of client devices over a communication network. The server has a central processing unit in communication with the graphics processing unit. The central processing unit has a system memory, and the graphics processing unit has a video memory. The server also includes a network interface. Each of the client devices has a network interface, a display, and one or more user input devices. The central processing unit executes or runs virtualization software to concurrently run a plurality of virtual machines. Each virtual machine has a virtual operating system for running one or more applications. Each application has graphical resources associated therewith that may be stored on the system memory. The virtual machines correspond to the plurality of client devices such that a first virtual machine corresponds to a first client device, and a second virtual machine corresponds to a second client device. The central processing unit or the graphics processing unit compresses graphical resources associated with the one or more applications and loads the compressed graphical resources into the video memory. Loading compressed graphical resources in place of their uncompressed counterparts reduces the amount of video memory used.

The foregoing summary does not encompass the claimed invention in its entirety, nor are the embodiments intended to be limiting. Rather, the embodiments are provided as mere examples.

### BRIEF DESCRIPTION OF THE DRAWING

FIG. 1 is a block diagram illustrating an embodiment of a memory usage reduction system in a virtualized environment.

FIG. 2 is a block diagram illustrating another embodiment of a memory usage reduction system in a virtualized environment.

FIG. 3 is a block diagram illustrating yet another embodiment of a memory usage reduction system in a virtualized environment.

FIG. 4 is a logic flow diagram depicting a data collection process.

FIG. 5 is a logic flow diagram depicting a compression quality process.

FIG. 6 is a logic flow diagram depicting a graphical resource load process.

### DETAILED DESCRIPTION

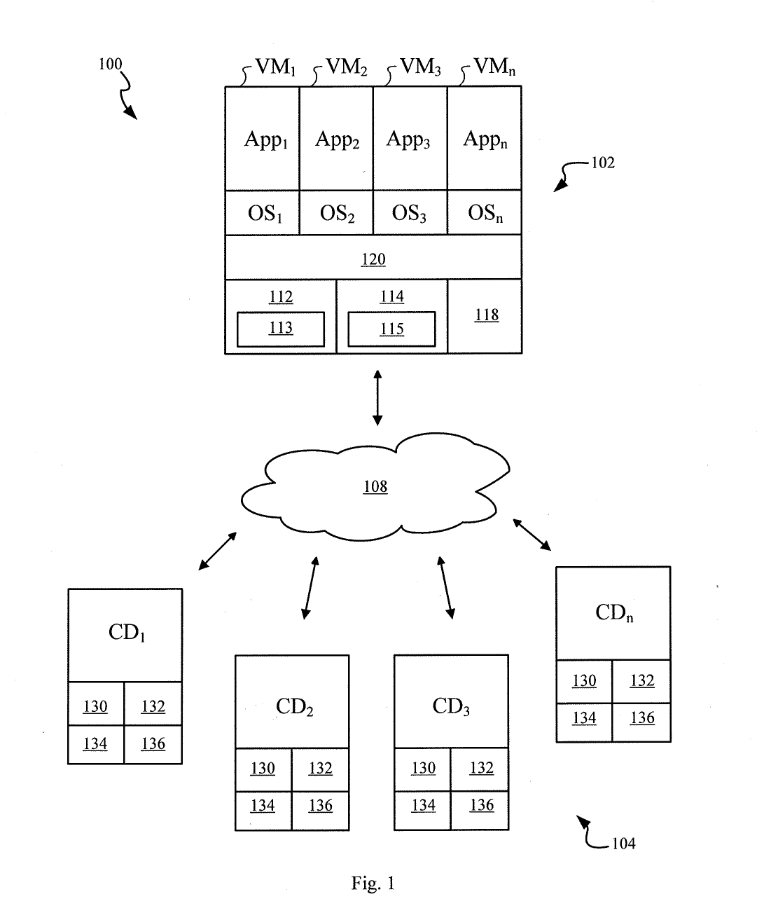

Referring now to the drawings, wherein like reference numerals denote like or corresponding parts throughout the drawings and, more particularly to FIGS. 1-6, there are shown various embodiments systems and methods for optimizing GPU memory usage.

More specifically, FIG. 1 illustrates an embodiment of a GPU memory usage reduction system 100 in a virtualized environment. The GPU memory usage reduction system 100 includes a server 102 in communication with one or more client devices 104 over a communication network 108 that may be wired or wireless. The server 102 is the host machine and the one or more client devices 104 are guest machines in the virtualized environment. The client devices 104 are further depicted as CD₁, CD₂, CD₃, and CDₙ in FIG. 1, with CDₙ representing the nth client device.

In the embodiment shown, the server 102 includes system hardware 110 having a CPU 112, a system memory 113 associated with the CPU, a GPU 114 (e.g., Nvidia Quadro 5800), a video memory 115 associated with the GPU, and a network interface 118. The server 102 also includes virtualization software 120, which is generally referred to as a virtualized machine manager or hypervisor that may be run by the CPU 112. The virtualization software 120 enables the CPU 112 of the host machine to concurrently run a plurality of virtual machines. In some embodiments, proper scheduling techniques may be implemented at the hypervisor level to obtain some degree of temporal isolation or performance isolation.

Thus, as shown in FIG. 1, the virtualization software 120 enables one or more virtual machines to run off the CPU 112. These one or more virtual machines are depicted as VM₁, VM₂, VM₃, and VMₙ; wherein VMₙ represents the nth virtual machine. Each of the one or more virtual machines has a respective virtual operating system OS₁, OS₂, OS₃, and OSₙ; wherein OSₙ represents the nth operating system. The operating systems may be the same or different. For example, OS₁ and OS₂ may be a version of the Windows operating system and OS₃ may be a version of Linux. Each virtual operating system may run one or more applications depicted as App₁ for OS₁, App₂ for OS₂, etc. Otherwise stated, App₁ may comprise one or more applications just as App₂ may also comprise one or more applications. Though numbered differently, App₁ through Appₙ may comprise the same or different application, or set of applications if more than one.

The one or more client devices CD₁, CD₂, CD₃, and CDₙ respectively correspond to VM₁, VM₂, VM₃, and VMₙ. As shown, the one or more client devices may each comprise a network interface 130, a video encoder 132, a display 134, and one or more user input devices 136. However, in some embodiments, the one or more client devices may comprise different or additional hardware. For example, CD₁ may not have any user input devices whereas CD₂, CD₃, and CDₙ have one or more user input devices and two or three displays. The one or more user input devices 136 may be mechanical, electromechanical, or electrical. For example, the one or more user input devices 136 may comprise touch sensing technology using resistive, infrared, optical, acoustic, mechanical, or capacitive technologies; switches; buttons; a computer mouse; a keyboard; and other input means adaptable to convey a message from a user of the corresponding client device to, e.g., the server 102. The one or more client devices may also generate data based on inputs irrespective of the user. For example, the one or more client devices may have at least one transducer or the like to send data relating to lighting, sound, or temperature conditions around the client device. As another example, the one or more client devices could further include an ultrasonic sensor to monitor movement around the client device.

In one embodiment, App₁ through Appₙ may include an application calling for the generation of graphical data for presentment on the display 134, respectively corresponding to CD₁ through CDₙ. For example, the application may be a game application or a 3-D rendering application that is respectively run on OS₁ through OSₙ. In such an example, the respective client devices may be electronic gaming machines, personal computers, mobile devices, or other electronic devices that call for user involvement such as an eReader (e.g., Amazon KINDLE or Barnes & Noble NOOK). The game application may be of any type, such as card games; dice games; random number games such as Bingo, Keno, and Roulette; slot machine style games; and any other game requiring user involvement. In yet other embodiments, the game application may also include games designed for use with eReaders that promote reading and socializing. For example, points may correspond to a particular book, magazine, or story. Upon being read or purchased, the user may be rewarded with these points that may accumulate, which may be redeemed, or otherwise cashed in. Such redemption may reward the user with some indicia (e.g., a medal for reading 10 best sellers) or trigger some other event such as a game of skill or chance. In one embodiment, App₁ is a card game application, App₂ is a slot machine style game application, App₃ is a slot machine style game application, App₄ is a Roulette game application, and App₅ is a 3-D rendering application. In such an embodiment, CD₁ through CD₄ may be an electronic gaming machine and CD₅ may be a personal computer.

Due to games generally being designed to fully utilize the video memory 115, it is desirable to reduce the memory footprint associated with games or software (e.g., game applications and 3-D rendering applications). More specifically, this memory usage reduction enables a single server to host a plurality of games or other software in a virtualized environment because the video memory 115 may be cached with graphical data corresponding to one or more applications.

In one embodiment, the system memory 113 stores graphical data, such as textures, corresponding to one or more applications (depicted as App₁ through Appₙ) in a lossless compressed state. During a pre-load boot process for an application, the graphical data stored in the system memory 113 corresponding to the application may be decompressed. The decompressed graphical data may then be compressed according to a lossy compression algorithm, such as S3TC. In some embodiments, the CPU 112 compresses the graphical data. In other embodiments, the GPU compresses the graphical data. In yet other embodiments, a separate compression module compresses the graphical data. The compressed graphical data is then stored on the video memory 115. During execution of the one more applications (e.g., playing a game), frames are rendered using the compressed graphical data. More specifically, the compressed graphical data may be decompressed in real-time, in some embodiments, by the GPU prior to rendering the frame calling for the graphical data.

Storing compressed graphical data in the video memory 115 results in a memory footprint reduction ratio at least equal to the compression ratio. For example, a game that would otherwise fully utilize the video memory 115 may be compressed according to a lossy compression algorithm having a compression ratio of approximately 3:1. In such an embodiment, the memory footprint reduction ratio is approximately 3:1. Otherwise stated, storing graphical data compressed according to an algorithm providing a compression ratio of 3:1 reduces the memory consumed by two-thirds. The two-thirds of available memory may then be used for additional applications. For example, the video memory 115 may store graphical data corresponding to three instances of the same game in the example provided. Thus, in a virtualized environment, such as the GPU memory usage reduction system 100, three virtualized machines VM₁, VM₂, and VM₃ may each respectively run the same game application off of the CPU 112 for client devices CD₁, CD₂, and CD₃ due to the memory footprint associated with each game application being reduced. Thus, in an embodiment where a game application is compressed according to an algorithm providing for a 2:1, 4:1, 8:1, 16:1, or 35:1 compression ratio, the GPU memory usage reduction system 100 may concurrently run 2, 4, 8, 16, or 35 instances of the same game application in a virtualized environment on different virtualized machines, respectively.

As previously indicated, the GPU memory usage reduction system 100 may concurrently run different applications as well. For example, the video memory 115 may have 1000 memory units. A first game application may cache 980 memory units worth of graphical data in an uncompressed state in video memory. However, if that graphical data is compressed according to a 4:1 compression ratio, the first game application may only consume about 245 memory units. In such an embodiment, memory space is saved, and therefore may be reallocated, even if less then all 980 memory units are compressed. For example, 400 out of the 980 memory units may be compressed according to a 4:1 compression ratio. Thus, rather than consume 980 memory units, the application may only consume about 580 memory units after compression.

As yet another example, a second game application may consume 2600 memory units when the corresponding graphical data is stored in an uncompressed state. However, if the graphical data corresponding to the second game application is compressed according to a 4:1 compression ratio, the second game application may only consume about 650 memory units. Thus, in some embodiments, storing compressed graphical data enables the CPU 112 to run more than one game application in a virtualized environment. In other embodiments, the memory footprint reduction enables more graphical data to be cached in a non-virtualized environment. In yet other embodiments, storing compressed graphical data enables the CPU 112 to run a game application that would otherwise not be supported by the system due to the video memory 115 not having enough memory space (i.e., memory units available).

The GPU memory usage reduction system 100 disclosed herein may be complemented by the teachings disclosed in commonly owned U.S. patent application Ser. No. 13/273,555, entitled Streaming Bitrate Control and Management. Accordingly, U.S. patent application Ser. No. 13/273,555 is incorporated by reference in its entirety and is filed concurrently herewith.

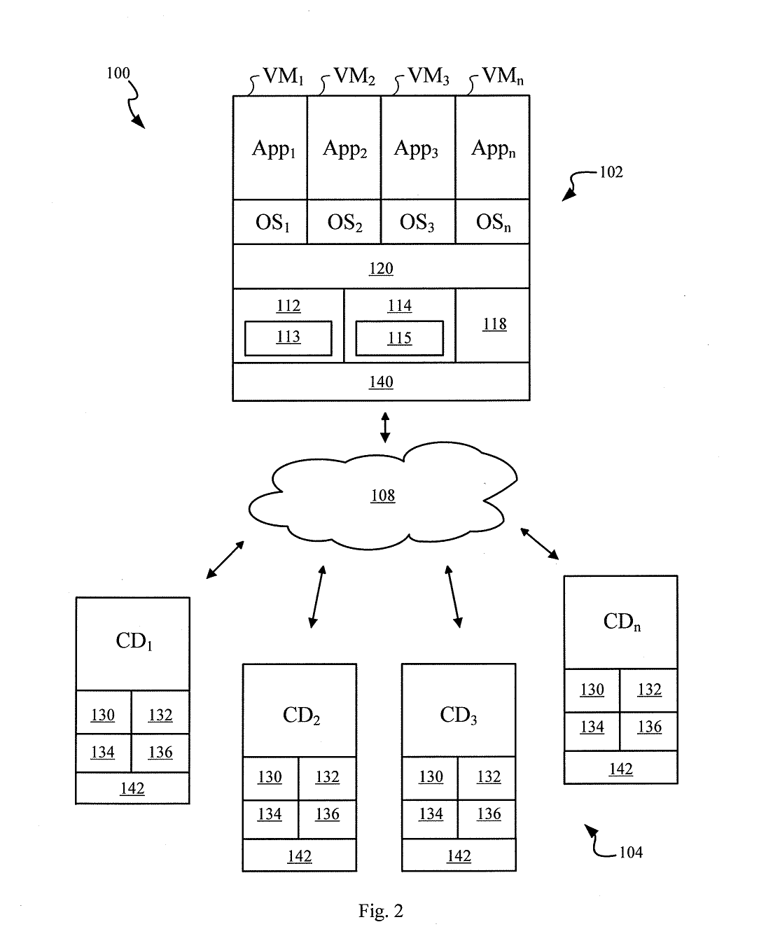

Referring now to FIG. 2, another embodiment of GPU memory usage reduction system 100 in a virtualized environment is shown. In this embodiment, GPU memory usage reduction system 100 includes the components as set forth in the embodiment shown in FIG. 1 as well as a compression module 140 to control the consumption of bandwidth over the communication network 108 as disclosed in commonly owned U.S. patent application Ser. No. 13/273,555, entitled Streaming Bitrate Control and Management. In such an embodiment, the client devices 104 may include a decompression module 142 to decompress (i.e., decode) the encoded data sent over the communication network 108 from the server 102.

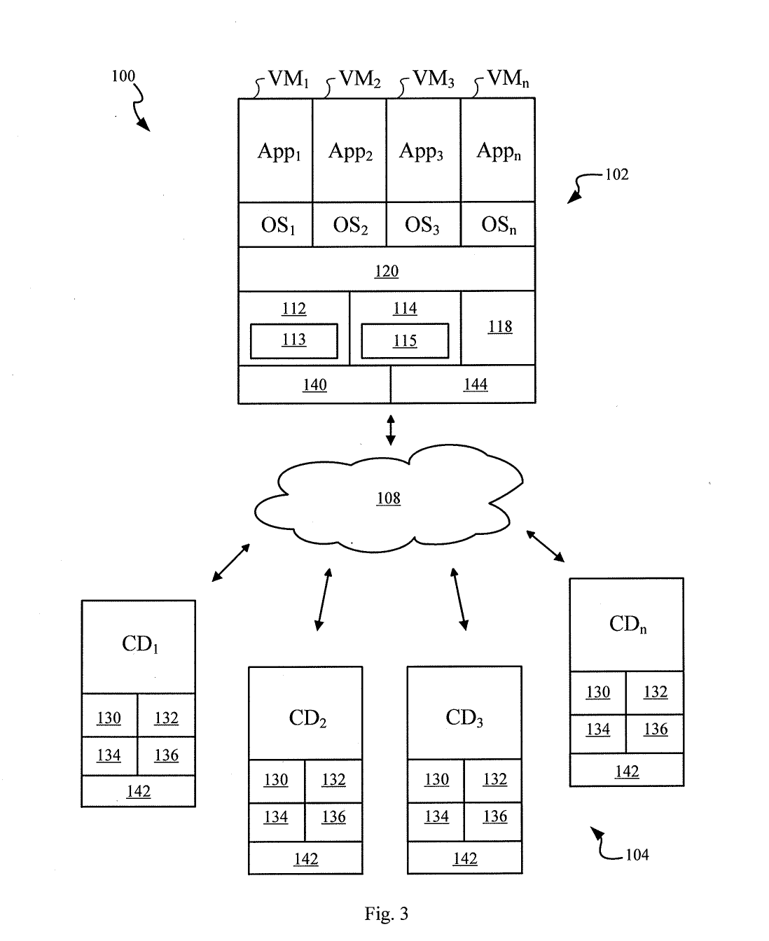

Referring now to FIG. 3, another embodiment of GPU memory usage reduction system 100 in a virtualized environment is shown. In this embodiment, GPU memory usage reduction system 100 includes the components as set forth in the embodiments shown in FIGS. 1 and 2 as well as an instruction management module 144 as disclosed in commonly owned U.S. patent application Ser. No. 13/273,555, entitled Streaming Bitrate Control and Management.

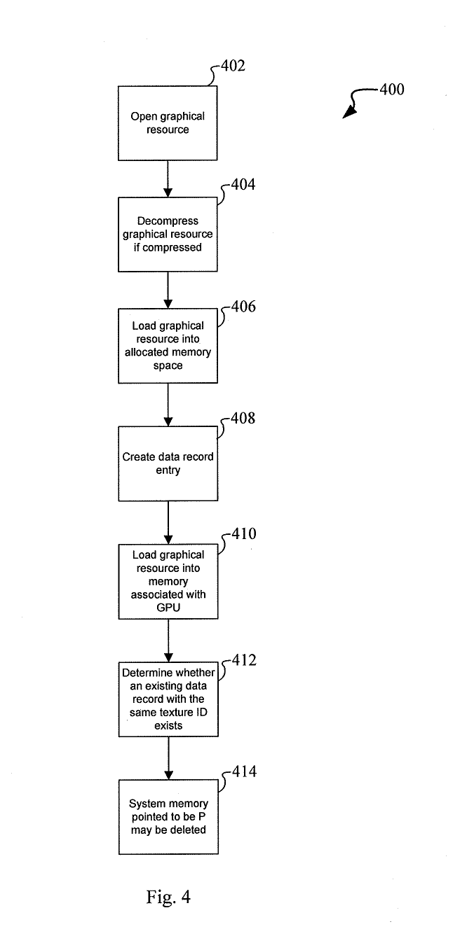

Referring now to FIG. 4, the GPU memory usage reduction system 100 employs a data collection process 400. The data collection process 400 creates a data record of graphical resources that are associated with static and dynamic textures by intercepting texture loads. Otherwise stated, the data collection process 400 determines which graphical resources are static and which are dynamic and makes a record of such a determination. This may affect which textures are loaded into the video memory 115 during the pre-load boot process in a compressed or uncompressed state. In some embodiments, all pre-loaded textures are compressed before storage in video memory 115. In other embodiments, only static textures are compressed before storage in video memory 115. In these embodiments, there may be textures that are not pre-loaded into video memory 115, which may be, instead, stored in the system memory 113 in the uncompressed state and loaded into video memory 115 when needed. In other embodiments, static textures may be categorized into two or more groups. For example, one group may consist of static textures that are compressed during the pre-load process and stored whereas a second group may consist of static textures that are not compressed before storage in video memory 115. Such grouping may be based on different one or more different criteria, such as file name, frame number, frame size, and the like.

The data collection process 400 may be virtualized on one or more virtual machines, such as those shown in FIGS. 1-3. In some embodiments, the data collection process 400 may not entail modification at the application level. Instead, the process may entail modification at the operating system level. In some embodiments, modification at the operating system level may remove jurisdictional requirements (e.g., where the client device is an electronic gaming machine in a gambling establishment). Modification at the operating system level may also remove the need to modify each application in the virtualized environment. In other embodiments, the data collection process 400 may entail modification at the application level. In such embodiments, jurisdictional requirements may or may not be a concern. For example, a game involving skill, such as a first person shooter, may either implement the data collection process at the application level or the operating system level.

In the embodiment shown in FIG. 4, the data collection process 400 may be implemented at the operating system level for a game application (e.g., a slot machine style game). The application, which in this embodiment is a game application, includes a resource list that contains a list of all the graphical resources associated with it (e.g., static textures and dynamic textures). In one embodiment, the data collection process may be run for a game application during initial deployment or while it is in the field (e.g., casino gaming environment). In another embodiment, the data collection process may be run while the game application (or client device that presents the game application) is out-of-service. In another embodiment, the process may be run while the game application is being tested or otherwise not in the field.

In one such embodiment, the game application may be run in a debug or showroom mode where each feature of the game can be operated by an operator, such as a test engineer. This ensures that every graphic is loaded and displayed before the data collection process is complete. In yet another embodiment, a test script may be implemented to control the game application to ensure that each possible image and animation is shown ensuring the data collection process encompasses the desired amount of graphical content. In some embodiments, it may be desired to build a data record of all graphical resources. However, it may be desired in other embodiments to build a data record of less than all of the graphical resources. This may occur, for example, where one is interested in only storing the most often used graphical resources in the video memory to further reduce the memory footprint. Accordingly, in some embodiments, the data collection process keeps track of the number of times a graphical resource is called for display. As such, only graphical resources that meet a pre-defined threshold (i.e., called a certain number of times) may be compressed prior to storage in video memory 115, according to some embodiments.

Referring now to the particulars of the data collection process 400, as each graphical resource is opened at block 402, the following occurs: (1) a frame counter variable representing the number of frames is set to zero; (2) the header of the graphical resource is read to determine the amount of memory necessary to decompress and/or store the graphical resource in system memory 113; (3) the requisite memory is allocated in system memory 113, which is pointed to by a pointer P; and (4) a texture identifier is generated by using, for example, an API such as OpenGL. Of course, other embodiments may generate a texture identifier without using the convenience of an API. Generating a texture identifier creates a reference to the texture that may be used for later rendering commands.

At block 404, the graphical resource is decompressed from either a lossy or lossless compressed state from the system memory 113. At block 406, the decompressed graphical resource is loaded into the allocated memory space pointed to by pointer P in system memory 113 (or a memory separate from the system memory 113). In embodiments where the graphical resource is not stored in the system memory 113 in a compressed state, the graphical resource may be loaded into the allocated memory space pointed to by pointer P. At block 408, the data collection process creates a data record for the graphical resource in the form of, for example, a table. In some embodiments, the data record includes a copy of the memory handle corresponding to pointer P, a copy of the file name corresponding to the graphical resource, a copy of the texture ID, the current frame count (via the frame counter variable), a flag indicating whether the graphical resource is static or dynamic, and the like. Depending on the embodiment, the flag may be set to a default value. This default value may indicate whether the graphical resource is static or dynamic.

At block 410, the uncompressed graphical resource stored in system memory 113 pointed to by pointer P is loaded into video memory 115. This task may be performed by the graphics driver with, for example, OpenGL providing a standard interface. Thus, for example, the “glTexImage2D” command may be used to achieve this task in some embodiments. The graphical resource load process may be intercepted, for example, at block 412 to determine whether an existing data record with the same texture identifier exists. In embodiments utilizing OpenGL, this may entail intercepting the “glTexImage2D” function.

A match indicates that the graphical resource is dynamic. As such, the flag is set to the appropriate value (or left as is if the default value is the appropriate value) to indicate whether the graphical resource is static or dynamic in the data record. This static/dynamic flag enables quick identification between static and dynamic graphical resources.

If no matching record is found with respect to the texture identifier, the data collection process determines whether a data record with a matching pointer P value exists. If a match occurs, the data collection process copies the texture identifier into the data record for the current graphical resource. More specifically, the match is the P value copied to the data record at block 408. Copying the texture identifier into the data record for the current graphical resource associates the current texture identifier with the file name corresponding to the graphical resource. Pointer P is used to make this association even though it is temporary because it is common to both the decompression function and the texture load. Such an association enables identification of the files that are static textures and those that are dynamic. In some embodiments, the data collection process identified in FIG. 4 associates file names and texture identifiers with each frame corresponding to a graphical resource. As such, each frame may be individually marked as static or dynamic.

Following block 412, the system memory 113 pointed to by P may be deleted at block 414 because it is no longer needed for the data collection process. When the data collection process is deemed complete, for example, where a test script or test run has finished, the contents of the data record generated by the data collection process may be saved or transmitted for analysis for further processing. Each entry in the data record corresponds to a graphical resource and has a static/dynamic flag indicating whether the resource is static or dynamic.

In some embodiments, only static textures are good candidates for texture compression. However, dynamic textures may be good candidates for texture compression in other embodiments. Some embodiments may even consider the frame count, file name, pointer P value, texture identifier, or combinations thereof to determine whether a graphical resource is to be texture compressed. For example, every odd, even, second, third, fourth, or tenth frame in an animation may be texture compressed, as opposed to compressing each frame.

For static textures derived from images, the frame counter variable is always zero because an image is a single frame. For static textures derived from animations, each frame of the animation may be decompressed into the system memory 113 in turn. The frame counter variable is incremented accordingly. An individual texture ID is generated for each frame of the animation. Each frame of the animation is also loaded into the video memory 115. As such, the data record for a non-streamed animation may include an entry in the data record for each frame such that each frame is individually marked as being static or dynamic.

For dynamic textures (i.e., streamed animations), the process results in the static/dynamic flag being set to a value designated to indicate that it is dynamic where the second frame of the streamed animation is loaded into the video memory 115. This occurs because an existing data record with the same texture identifier was found to exist at block 412. This may occur in an embodiment, for example, utilizing OpenGL where the “glTexImage2D” command is re-using the previous texture identifier. Thus, calling the same file more than once may result in a different pointer P value but the same texture identifier. Such a scenario results in flagging the current frame as a dynamic texture. Depending on the embodiment, the data collection process may set the static/dynamic flag of the first frame corresponding to a streamed animation to dynamic once the process determines that the frames following it have been marked as such. In other embodiments, the first frame of a streamed animation may be left as being marked as a static texture without alteration.

In some embodiments, one or more blocks in data collection process 400 may be executed in parallel where applicable. In other embodiments, one or more blocks may be executed in a serial fashion where applicable. In yet other embodiments, data collection process 400 may execute one or more blocks in serial and one or more blocks in parallel where applicable.

In another aspect of one embodiment, the data collection process 400 intercepts/modifies three function calls at block 402 (open resource as a file), block 404 (decompress graphical resource), and block 410 (loading of the decompressed graphical resource into the video memory 115).

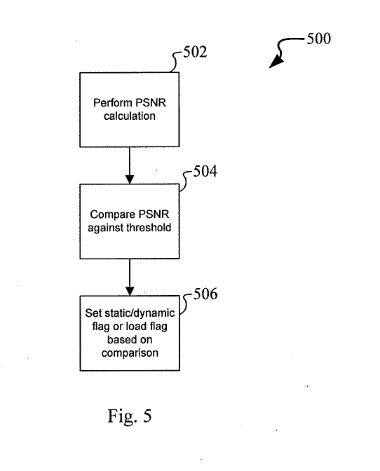

Referring now to FIG. 5, the GPU memory usage reduction system 100 may employ a compression quality process 500 for each texture identified as being static. At block 500, each image (single frame) or each animation (multiple frames) that is designated as being a static texture is compressed according to a compression algorithm, for example, the BC7 algorithm. In some embodiments, each texture is compressed according to multiple compression algorithms, such as BC1, BC7, and the like.

At block 502, a peak-signal-to-noise ratio (PSNR) calculation is performed on the original frame and the texture compressed version of the same frame. At block 504, the resultant PSNR is compared against a threshold value. At block 506, the static/dynamic flag may be altered or set based on the comparison. For example, if the process determines that the PSNR meets a certain threshold (e.g., 30 dB or lower in some embodiments), the static/dynamic flag may be marked as dynamic. In other embodiments, the static/dynamic flag may not be altered, and instead, a load flag is used. The load flag may be used to keep track of which static and dynamic textures are to be loaded into video memory 115 in a compressed state. This additional flag enables one to maintain the first determination of whether the graphical resource is static or dynamic but also keeps a record of which graphical resources are being loaded into the video memory 115.

In one embodiment of the memory usage reduction system 100, the threshold may be of a value greater than or less than 30 dB. In some embodiments, different PSNR thresholds may be used for images and animations because compression artifacts may be less visible in animations when compared to images, or vice versa, depending on the length of time of the frame is displayed. As such, the PSNR threshold for frames corresponding to animations may be lower than the PSNR threshold for images, or vice versa. In embodiments where each texture is compressed according to multiple compression algorithms, the PSNR calculation is performed on each frame corresponding to each compression algorithm to determine the optimal compression algorithm to use for that particular texture. Thus, a higher compression ratio may be deemed, in some embodiments, optimal over a lower compression ratio where the texture is part of a fast moving animation because the compression artifacts may be less visible.

As a result of each graphical resource being individually tested at block 502, it is possible for an animation to include frames designated as dynamic and others designated as static (when only the static/dynamic flag is used). In embodiments where a load flag is used, the value of the static/dynamic flag may be left to maintain the determinations made during the data collection process 400. Thus, even though each frame in a given animation may be marked as being static, the load flag may be used to indicate whether one or more of these frames are to be compressed before loading into the video memory 115 or even loaded into the video memory at all. For example, the load flag could be 2 bits in length and indicate one of the following: (1) ignore the load flag, (2) load the frame into video memory in a compressed state, (3) load the frame into video memory in an uncompressed state, or (4) do not load the frame into video memory at all and treat it as a dynamic texture (which are not generally pre-loaded into the video memory).

Of course, the load flag may have a default value just as the static/dynamic flag may have one. Additionally, the data collection process may also implement the load flag. For example, every time a frame is determined to be a static texture, the static/dynamic flag is set to indicate this, and the load flag is also set to indicate the default load treatment (e.g., frame is compressed before loading it into the video memory 115).

After the data collection process 400, and the compression quality process 500 if implemented, the data record provides a definitive list that identifies graphical resources as being static or dynamic. Using the data record, static textures (or textures marked as static even though they are dynamic or textures marked with a load flag indicating compression thereof) may be automatically compressed during normal boot-up operation or prior to normal game operation. Thus, rather than only store uncompressed textures in the video memory 115, compressed textures are also stored. Doing so reduces the memory footprint at no discernible cost to game display performance because it is done during the boot process (or prior to normal game operation). During game operation, the compressed textures may be decompressed in real-time by the GPU.

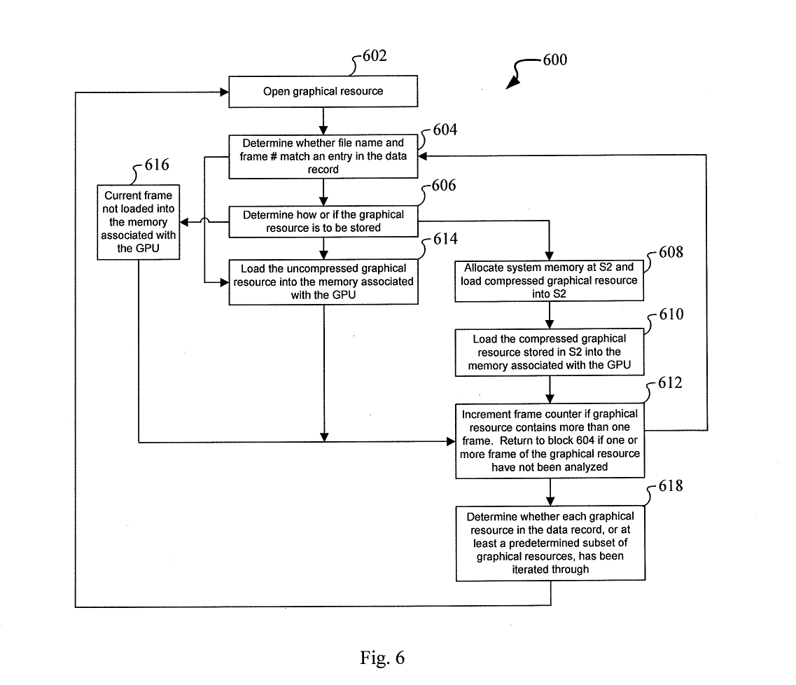

Referring now to FIG. 6, the GPU memory usage reduction system 100 may employ a graphical resource (texture) load process 600 in accordance with the data record built from the data collection process 400 and the quality process 500, if implemented. Similar to block 402, as each graphical resource is opened at block 602 for loading the graphical resource into video memory 115, the following occurs: (1) a frame counter variable representing the number of frames is set to zero; (2) the header of the graphical resource is read to determine the amount of memory necessary to decompress and/or store the graphical resource in system memory 113; (3) the requisite memory is allocated in system memory 113 at S1; and (4) a texture identifier is generated by using, for example, an API such as OpenGL. Of course, other embodiments may generate a texture identifier without using the convenience of an API.

Following block 602 (opening of graphical resource), the data record associated with the data collection process 400 is referenced at block 604 to determine whether the file name and frame number corresponding to the current graphical resource match an entry in the data record. If such a match does not exist, the process proceeds to block 614. However, if a match is found, block 604 proceeds to block 606 to determine whether the graphical resource is to be stored in the video memory 115 in a compressed state, uncompressed state, or even stored in the video memory at all.

The determination at block 606 may be based on the static/dynamic flag value and/or the load flag value stored in the data record corresponding to the current graphical resource. For example, in some embodiments, if the static/dynamic flag value indicates that the current graphical resource is dynamic, the process may proceed to block 616 from block 606. At block 616, the current frame is not loaded into the video memory 115 and the process proceeds to block 612 (increment frame counter and return to block 604 if applicable). If the static/dynamic flag value indicates that the current graphical resource is static, the process may proceed to block 608.

In other embodiments, if the load flag value indicates that the current graphical resource (whether static or dynamic) is to be loaded into the video memory 115 in the uncompressed state, the process may proceed to block 614 (load uncompressed graphical resource into the video memory) from block 606. However, if the load flag value indicates that the current graphical resource (whether static or dynamic) is to be loaded into the video memory 115 in the compressed state, the process may proceed to block 608 (allocate system memory at S2 and load compressed graphical resource into S2). Further yet, if the load flag value indicates that the current graphical resource (whether static or dynamic) is not to be loaded into the video memory 115, the process may proceed to block 616 (frame not loaded into video memory). In yet other embodiments, the process may only continue on from block 606 if both the static/dynamic flag and load flag are each of a certain value.

At block 608, a second memory allocation is made at S2 in system memory 113. In some embodiments, S2 is the same location in memory as S1. However, in other embodiments, S2 is different than S1. A compressed version of the graphical resource may be loaded into the memory location S2 at this time. In some embodiments, this entails reading a previously stored, compressed version of the graphical resource into memory location S2. This previously stored, compressed graphical resource may be stored on the system memory 113. In these embodiments, the process proceeds to block 610 after S2 is loaded with the compressed version of the graphical resource.

In other embodiments, the graphical resource may be compressed at this time by, for example, the GPU or an encoder distinct from the GPU. Accordingly, the graphical resource may be decompressed from either a lossy or lossless compressed state in the system memory 113 and loaded into memory location S1. If the graphical resource was not compressed, it may be read directly into memory location S1 or read from its stored location and not even read into S1. The uncompressed graphical resource may then be encoded pursuant to a compression algorithm, and stored in memory location S2. Following storage of the compressed graphical resource in memory location S2, the process continues to block 610.

At block 610, the compressed graphical resource stored in memory location S2 at block 608 is loaded into the video memory 115. Block 610 then proceeds to block 612.

At block 612, the process increments the frame counter variable for graphical resources consisting of more than one frame (animations), and returns to block 604. Returning to block 604 for each frame in an animation ensures that each frame is analyzed within each graphical resource. Otherwise, the process proceeds to block 618.

In some embodiments, the frame counter variable is incremented by 1 at block 610. In other embodiments, the frame counter variable is incremented by a value different than 1, such as 2, 4, 8, and the like. In such embodiments, increments above 1 reduce the memory footprint because fewer frames are being loaded into the video memory 115. This may be desired, for example, where an animation consists of what may be perceived as a slow-motion movie because of the subtle changes in the image between each frame. By only loading every second frame or every fourth frame into the video memory 115, and only using these frames when called for rendering, the animation speed can effectively be changed to what may be perceived as normal movement or faster than normal movement.

At block 618, the process determines whether each graphical resource in the data record, or at least a predetermined subset of graphical resources, has been iterated through. If the graphical resource has not been iterated through, the process returns to block 602. If the graphical resource has been iterated through, the process may end to enable normal operation of the corresponding application.

Now with respect to block 614, which follows blocks 604 (determination of whether the file name and frame number corresponding to the current graphical resource march an entry in the data record) or 606 (determination of flag(s) value(s)), the graphical resource may be decompressed from either a lossy or lossless compressed state in the system memory 113 and loaded into memory location S1. The uncompressed frame may then be loaded into the video memory 115. Block 614 then proceeds to block 612.

In some embodiments, one or more blocks in load process 600 may be executed in parallel where applicable. In other embodiments, one or more blocks may be executed in a serial fashion where applicable. In yet other embodiments, load process 600 may execute one or more blocks in serial and one or more blocks in parallel where applicable.

Those of ordinary skill in the art will appreciate that one or more circuits and/or software may be used to implement the methods and processes described herein. Circuits refers to any circuit, whether integrated or external to a processing unit. Software refers to code or instructions executable by a processing unit to achieve the desired result. This software may be stored locally on a processing unit or stored remotely and accessed over a communication network.

The various embodiments and examples described above are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for reducing the amount of memory consumed by a graphics processing unit having a video memory in a system involving a central processing unit having a system memory, the method comprising:
performing a data collection process on one or more of the graphical resources stored in the system memory as the one or more graphical resources are read from the system memory and stored in the video memory;
building a data record based on information collected during the data collection process;
determining whether one or more of the graphical resources are to be compressed prior to loading into the video memory based on the data record;
compressing the one or more graphical resources identified to be loaded into the video memory in the compressed state; and
loading compressed graphical resources into the video memory based on the data record.

2. The method of claim 1, wherein the data collection process comprises:
opening a first graphical resource from the system memory;
allocating memory space, which has a corresponding memory handle, in the system memory;
setting a frame counter for counting the number of frames associated with each graphical resource; and
generating a texture identifier.

3. The method of claim 2, wherein the data collection process further comprises:
decompressing the first graphical resource, if compressed;
loading the decompressed, first graphical resource into the allocated memory space, and if not compressed, loading the first graphical resource as it is stored in the system memory into the allocated memory space; and
loading the first graphical resource stored in the allocated memory space into the video memory.

4. The method of claim 3, wherein building the data record comprises:
copying the memory handle corresponding to the allocated memory space for the first graphical resource into the data record;
copying the frame number into the data record;
copying a file name corresponding to the first graphical resource into the data record; and
copying the texture identifier to into the data record.

5. The method of claim 4, wherein the data collection process further comprises:
determining whether an existing data record with the same texture identifier exists; and
setting a flag indicative of whether the frame is static or dynamic in the data record based on this determination.

6. A method for reducing the amount of memory consumed by a graphics processing unit having an associated memory in a system involving a first processing unit having an associated memory, the method comprising:
performing a data collection process on one or more of the graphical resources stored in the memory associated with the first processing unit as the one or more graphical resources are read from the memory associated with the first processing unit and stored in the memory associated with the graphics processing unit;
building a data record based on information collected during the data collection process;
determining whether one or more of the graphical resources are to be compressed prior to loading into the memory associated with the graphics processing unit based on the data record;
compressing the one or more graphical resources identified to be loaded into the memory associated with the graphics processing unit in the compressed state;
loading compressed graphical resources into the memory associated with the graphics processing unit based on the data record; and
performing a compression quality process on one or more of the graphical resources.

7. The method of claim 6, wherein the compression quality process comprises:
performing a peak-signal-to-noise ratio calculation on an original and compressed version of a frame corresponding to one of the graphical resources; and
comparing the result of the calculation against a threshold value.

8. The method of claim 7, wherein the compression quality process further comprises setting either a flag indicative of whether the frame is static or dynamic or a load flag based on the comparison.

9. The method of claim 8, wherein the load flag indicates one of the following: the load flag is to be ignored, the graphical resource is to be loaded into the memory associated with the graphics processing unit in the compressed state, the graphical resource is to be loaded into the memory associated with the graphics processing unit in the uncompressed state, or the graphical resource is not to be loaded into the memory associated with the graphics processing unit.

10. The method of claim 6, wherein the data collection process comprises:
opening a first graphical resource from the memory associated with the first processing unit;
allocating memory space, which has a corresponding memory handle, in the memory associated with the first processing unit;
setting a frame counter for counting the number of frames associated with each graphical resource; and
generating a texture identifier.

11. The method of claim 10, wherein the data collection process further comprises:
decompressing the first graphical resource, if compressed;
loading the decompressed, first graphical resource into the allocated memory space, and if not compressed, loading the first graphical resource as it is stored in the memory associated with the first processing unit into the allocated memory space; and
loading the graphical resource stored in the allocated memory space into the memory associated with the graphics processing unit.

12. The method of claim 11, wherein building the data record comprises:
copying the memory handle corresponding to the allocated memory space for the first graphical resource into the data record;
copying the frame number into the data record;
copying a file name corresponding to the first graphical resource into the data record; and
copying the texture identifier to into the data record.

13. The method of claim 12, wherein the data collection process further comprises:
determining whether an existing data record with the same texture identifier exists; and
setting a flag indicative of whether the frame is static or dynamic in the data record based on this determination.

14. The method of claim 13, wherein the compression quality process comprises:
performing a peak-signal-to-noise ratio calculation on an original and compressed version of a frame corresponding to one of the graphical resources; and
comparing the result of the calculation against a threshold value.

15. The method of claim 14, wherein the compression quality process further comprises setting either a flag indicative of whether the frame is static or dynamic or a load flag based on the comparison.

16. The method of claim 15, wherein the load flag indicates one of the following: the load flag is to be ignored, the graphical resource is to be loaded into the memory associated with the graphics processing unit in the compressed state, the graphical resource is to be loaded into the memory associated with the graphics processing unit in the uncompressed state, or the graphical resource is not to be loaded into the memory associated with the graphics processing unit.

17. A memory usage reduction system comprising:
a first processing unit having an associated memory and a graphics processing unit having an associated memory, wherein the first processing unit is in communication with the graphics processing unit, wherein the first processing unit and the graphics processing unit have software or one or more circuits for:
performing a data collection process on one or more of the graphical resources stored in the memory associated with the first processing unit as the one or more graphical resources are read from the memory associated with the first processing unit and stored in the memory associated with the graphics processing unit;
building a data record based on information collected during the data collection process;
determining whether one or more of the graphical resources are to be compressed prior to loading into the memory associated with the graphics processing unit based on the data record;
compressing the one or more graphical resources identified to be loaded into the memory associated with the graphics processing unit in the compressed state; and
loading compressed graphical resources into the memory associated with the graphics processing unit based on the data record.

18. The system of claim 17, wherein the data collection process, executed by the software or the one or more circuits, comprises:
opening a first graphical resource from the memory associated with the first processing unit;
allocating memory space, which has a corresponding memory handle, in the memory associated with the first processing unit;
setting a frame counter for counting the number of frames associated with each graphical resource; and
generating a texture identifier.

19. The system of claim 18, wherein the data collection process, executed by the software or the one or more circuits, further comprises:
decompressing the first graphical resource, if compressed;
loading the decompressed, first graphical resource into the allocated memory space, and if not compressed, loading the first graphical resource as it is stored in the memory associated with the first processing unit into the allocated memory space; and
loading the graphical resource stored in the allocated memory space into the memory associated with the graphics processing unit.

20. The system of claim 19, wherein building the data record, executed by the software or the one or more circuits, comprises:
copying the memory handle corresponding to the allocated memory space for the first graphical resource into the data record;
copying the frame number into the data record;
copying a file name corresponding to the first graphical resource into the data record; and
copying the texture identifier to into the data record.

21. The system of claim 20, wherein the data collection process, executed by the software or the one or more circuits, further comprises:
determining whether an existing data record with the same texture identifier exists; and
setting a flag indicative of whether the frame is static or dynamic in the data record based on this determination.

22. A memory usage reduction system in a virtualized environment comprising:
a server having a central processing unit with a system memory, a graphics processing unit with a video memory and a network interface, wherein the central processing unit is in communication with the graphics processing unit, and wherein the central processing unit executes virtualization software to concurrently run a plurality of virtual machines, each virtual machine having a virtual operating system for running one or more applications;
a plurality of client devices in communication with the server over a communication network such that a first virtual machine corresponds to a first client device and a second virtual machine corresponds to a second client device, wherein each of the client devices has a network interface, a display, and one or more user input devices; and
wherein the central processing unit or the graphics processing unit compresses graphical resources associated with the one or more applications and loads the compressed graphical resources into the video memory.

23. The system of claim 22, wherein the central processing unit loads uncompressed graphical resources into the video memory.

24. The system of claim 22, wherein the graphics processing unit decompresses the compressed graphical resources loaded into the video memory when the compressed graphical resources are needed for rendering by the graphics processing unit.

25. The system of claim 24, wherein the graphics processing unit decompresses the compressed graphical resources in real-time when needed for rendering by the graphics processing unit.

26. The system of claim 22, wherein the one or more applications include a game of a chance or a game of skill.

27. The system of claim 22, wherein the server further includes a compression module in communication with the graphics processing unit that receives rendered data from the graphics processing unit.

28. The system of claim 27, wherein the one or more of the client devices include a decompression module configured to receive compressed data from the compression module over the communication network.

29. The system of claim 22, wherein the central processing unit and the graphics processing unit have software or one or more circuits for performing a data collection process on graphical resources stored in the system memory as the graphical resources are read from the system memory and stored in the video memory.

30. The system of claim 29, wherein the central processing unit and the graphics processing unit have software or one or more circuits for building a data record based on information collected during the data collection process.

31. The system of claim 30, wherein the central processing unit and the graphics processing unit have software or one or more circuits for determining whether the graphical resources are to be compressed prior to loading into the video memory based on the data record.

32. The system of claim 31, wherein the central processing unit or the graphics processing unit compresses graphical resources identified to be loaded into the video memory in the compressed state based on the data record.

33. The system of claim 32, wherein the central processing unit or the graphics processing unit loads, based on the data record, the compressed graphical resources into the video memory.
